(19) United States
(12) Patent Application Publication
(10) Pub. No.: US 2008/0062385 A1
(43) Pub. Date: Mar. 13, 2008

(54) Method of monitoring polarization performance, polarization measurement assembly, lithographic apparatus and computer program product using the same

(75) Inventor: Michel Fransois Hubert Klaassen, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/399,592

(22) Filed: Apr. 7, 2006

(51) Int. Cl. G03B 21/14

(52) U.S. Cl. 353/20

(57) ABSTRACT

The invention relates to a method of monitoring a polarization performance of an optical system in a lithographic projection apparatus. The lithographic projection apparatus has an illumination system configured to condition a radiation beam and a support constructed to support a patterning device. The patterning device is capable of imparting the radiation beam with a pattern in its cross-section to form a patterned radiation beam, and provided with a polarization sensitive feature. In the method, first the patterning device, a detector and a projection system are provided such that upon illumination of the polarization sensitive feature, an image of this feature is projected by the projection system on the detector. Then, an image intensity of the image is measured. Finally, a polarization-related parameter based on the image intensity as measured is determined.

### FIELD

The present invention relates to a method of monitoring polarization performance in an optical system in a lithographic apparatus and a computer program product, when executed by a processor, for performing such a method. Additionally, it relates to a polarization measurement assembly and a lithographic apparatus comprising such a polarization measurement assembly.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to create more sophisticated and faster circuitry, the semiconductor industry strives to reduce the size of circuit elements. Lithographic apparatus with a shorter exposure wavelength and a higher numerical aperture are desired to decrease the critical dimension (CD) of features being manufactured. Optimized polarization control of exposure light can have a substantial impact on imaging. An optimized recombination of diffraction orders results into higher contrast of an image that is formed at substrate level.

### SUMMARY

It is desirable to provide a method of monitoring a polarization performance of an optical system in a lithographic projection apparatus with an improved performance in view of the prior art.

In an embodiment, there is provided a method of monitoring polarization performance of an optical system in a lithographic projection apparatus, the lithographic projection apparatus comprising: an illumination system configured to condition a radiation beam and a support constructed to support a patterning device, the patterning device being capable of imparting the radiation beam with a pattern in its cross-section to form a patterned radiation beam; wherein the method comprises:

providing the patterning device, the patterning device provided with a polarization sensitive feature;

providing a detector configured to detect an image of the polarization sensitive feature;

providing a projection optical system configured to project, upon illumination of the polarization sensitive feature, the image on the detector;

measuring an image intensity of the image of the polarization sensitive feature as projected on the detector at a first moment in time;

determining a polarization-related parameter based on the image intensity as measured at the first moment in time.

In an embodiment, there is provided to a polarization measurement assembly to measure polarization of a beam of radiation traversing through a projection optical system, the polarization measurement assembly comprising:

an optical element provided with a polarization sensitive feature;

a detector comprising a slit and an image sensor, the detector being arranged to receive an image of the polarization sensitive feature upon illumination of the optical element with the beam of radiation, the image being projected on the detector by means of the projection optical system.

In an embodiment, there is provided a lithographic apparatus comprising: an illumination system configured to condition a radiation beam;

a support constructed to support a patterning device, the patterning device being capable of imparting the radiation beam with a pattern in its cross-section to form a patterned radiation beam;

a substrate table constructed to hold a substrate; and

a projection system configured to project the patterned radiation beam onto a target portion of the substrate;

wherein the lithographic apparatus further comprises such a polarization measurement assembly.

In an embodiment, there is provided a device manufacturing method comprising transferring a pattern from a patterning device onto a substrate using such a lithographic apparatus.

In an embodiment, there is provided to a computer program product for performing, when executed by a processor, aforementioned method of monitoring a polarization performance of an optical system.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 schematically depicts an embodiment of a polarization measurement assembly according to an embodiment of the present invention;

FIG. 3a schematically depicts a more detailed view of a first embodiment of the polarization measurement assembly of FIG. 2;

FIG. 3b depicts a graph showing a typical result of a polarization measurement with the polarization measurement assembly of FIG. 3a;

FIG. 4 depicts a flow chart of a method of measuring an integrated intensity of an image by using the polarization measurement assembly of FIG. 3a.

FIG. 5a schematically depicts a more detailed view of a second embodiment of a polarization measurement assembly of FIG. 2;

FIG. 5b depicts a graph showing a typical result of a polarization measurement with the polarization measurement assembly of FIG. 5a;

FIG. 6 depicts a flow chart of a method of measuring a integrated intensity of an image by using the polarization measurement assembly of FIG. 5a.

### DETAILED DESCRIPTION

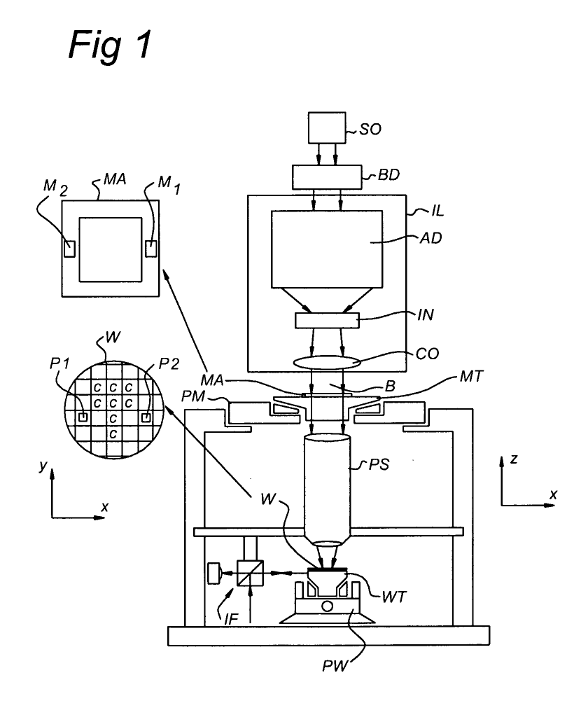

FIG. 1 schematically depicts a lithographic apparatus according to one embodiment of the invention. The apparatus comprises:
an illumination system (illuminator) IL configured to condition a radiation beam B. (e.g. UV radiation or EUV radiation).
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and
a projection system (e.g. a refractive projection lens system) PS configured to project a pattern imparted to the radiation beam B by patterning device MA onto a target portion C. (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic. apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of an exposure field limits the size of the target portion C imaged in a single static exposure.

2. In scan mode, the mask table MT and the substrate table WT are scanned synchronously while a pattern imparted to the radiation beam is projected onto a target portion C. (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

In lithography, a higher resolution may be obtained if the numerical aperture (NA) of the projection system PS increases. However, increasing the NA of the projection system typically results in having large angles of incidence of an image forming diffraction orders at wafer level. This will result in strong contrast degradation when an electric field vector of diffracted light beams is not aligned perpendicular to a plane of incidence. To check whether the polarization of the light employed is correct, a polarization measurement assembly is used

Any polarization state of an illumination beam can be effectively decomposed into a component parallel to a main orientation of patterning features on a patterning device, e.g. a mask MA, and one component perpendicular to aforementioned orientation. Generally the first polarization component as mentioned is referred to as so-called “S-polarization” while the latter component generally is referred to as “P-polarization”. The two components are orthogonal to each other. In view of aforementioned discussion related to the alignment of the electric field with respect to the plane of incidence, S-polarized illumination of a patterning device may be optimized.

When two S-polarized light beams interfere, the interference will be more constructive, as is well known to persons skilled in the art. Similarly, when two P-polarized light beams interfere, the interference will be less efficient, with a lower image contrast as a result.

Embodiments of the invention are based on the insight that the different interference properties of S-polarized light and P-polarized light can be used to monitor polarization properties of an image forming light beam at the substrate level.

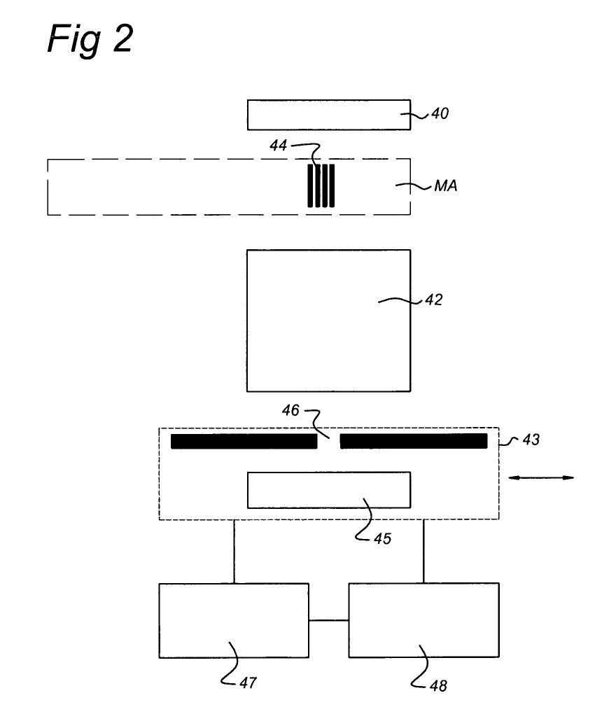

FIG. 2 schematically depicts an embodiment of a polarization measurement assembly according to the present invention. In this embodiment, illumination optics 40, a reticle MA, projection optics 42, e.g. a projection optical system comprising a projection lens or the like, and a detector 43 are used. The reticle MA comprises a polarization sensitive feature 44. The polarization sensitive feature 44, can be, e.g., a pattern of dense lines and spaces comprising alternating chromium lines and transparent spaces.

The detector 43 comprises an image sensor 45 in front of which a slit 46 is positioned. The slit 46 enables localized image intensity sampling. The projection optics 42 is arranged to project an image, i.e. a so-called aerial image, on the slit 46. The aerial image geometry is highly dependent on the geometry of the polarization sensitive feature 44 and the polarization state of the light at substrate level. The geometry of the slit 46 determines what part of the aerial image is measured, i.e. integrated, by the image sensor 45.

The image sensor 45 may be connected with a processor 47 and a memory 48. The processor 47 may use information obtained with the image sensor 45 to perform operations. The information may be obtained from the image sensor 45 directly or retrieved from the memory 48 in which the information obtained with the image sensor 45 may be stored.

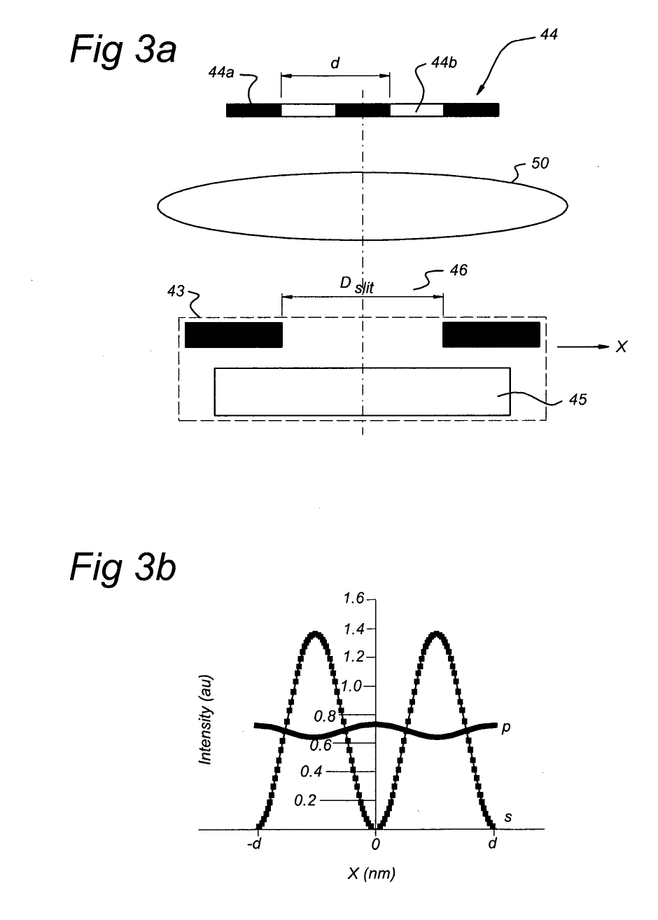

FIG. 3a schematically depicts a more detailed view of an example of a polarization measurement assembly as depicted in FIG. 2. In the example, the polarization sensitive feature 44 comprises a pattern of dense lines 44a and spaces 44b, in which the lines 44a and spaces 44b are equal in width and the lines 44a are spaced apart at a distance d, i.e. the pitch equals d. In an embodiment, pitch d is about ⅔ of the width of slit 46. Thus, if a width of slit 46 of about 200 nm is used, the pitch d is about 133 nm. By moving the detector 43, which comprises both the slit 46 and the image sensor 45, in a direction substantially perpendicular to the pattern of dense lines 44a and spaces 44b, in FIG. 3a denoted as X-direction, the aerial image can be sampled at different positions.

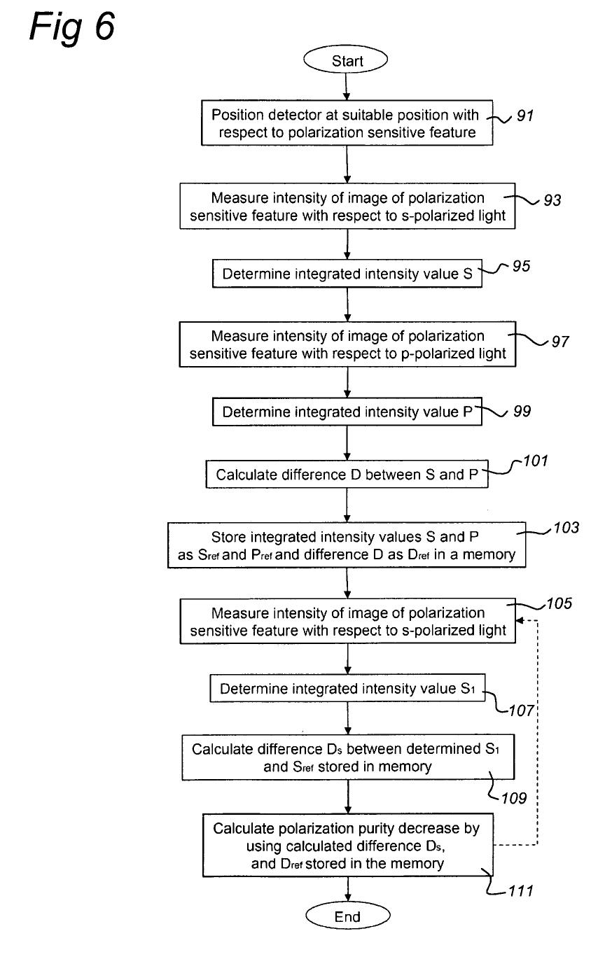

FIG. 3b depicts a graph showing a result of a polarization measurement with the polarization measurement assembly of FIG. 6a. In this embodiment, the width of slit 46 is 1.5 times the pitch d. Thus, in case d=133 nm, the slit width is 1.5*d≈200 nm. In this graph, the aerial image intensity distribution for both s-polarized light and p-polarized light is shown. As the interference of the diffraction orders for a polarization sensitive feature 44 is more constructive for s-polarized light, this type of polarization shows a large intensity variation as a function of position. The interference of the diffraction orders for a polarization sensitive feature 44 is less efficient for p-polarized light. Using this type of polarization will give a less pronounced dependency of the aerial image intensity as a function of position.

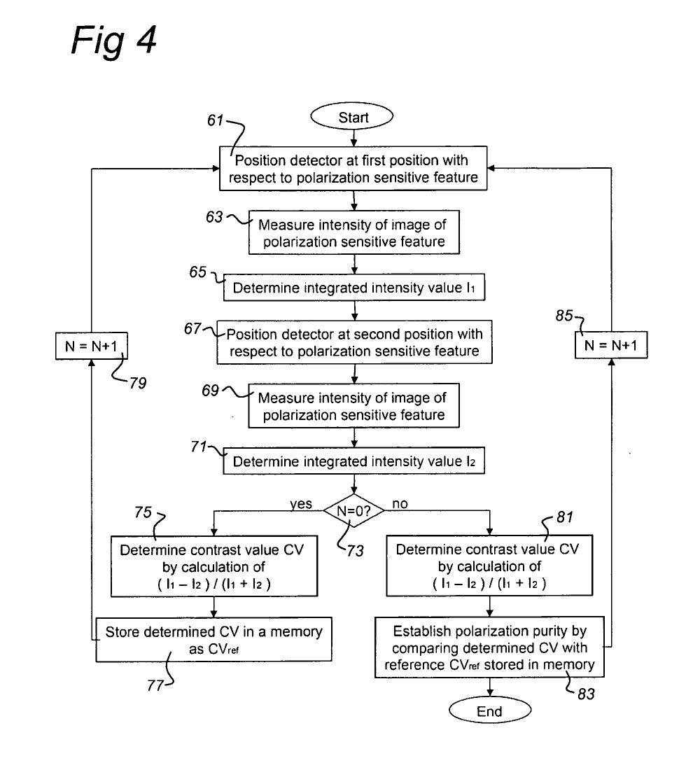

FIG. 4 depicts a flow chart of a measurement method of monitoring the development of polarization characteristics of a radiation beam in a lithographic apparatus by means of the polarization measurement assembly of FIG. 3a. The operations in the flow chart may be part of a computer program product that may be executed by processor 47. Such a computer program may be stored on a data carrier (not shown).

First, in step 61, the detector 43 is positioned at a first position with respect to the polarization sensitive feature 44. A suitable first position may be a position at which the intensity of the image at the center of the image sensor 45 corresponds to either a maximum or a minimum value of the s-polarization intensity. Consider the case that aforementioned dimension ratio of pitch d and slit width Dₛₗᵢₜ is present, i.e. d:Dₛₗᵢₜ=2:3. In that case either two peaks and one valley are sampled, as shown in FIG. 3b or, alternatively, by shifting the detector 43 half a pitch d, i.e. 66.5 nm, one peak and two valleys are sampled. At the first position, in step 63, an intensity of the image of the polarization sensitive feature 44 is measured. Based on this measurement, in step 65, an integrated intensity value I₁ can be determined. Subsequently, in step 67, the detector 43 is moved towards a second position. At the second position, in step. 69, again an intensity of the image of the polarization sensitive feature 44 is measured. Based on this measurement, in step 71, an integrated intensity value I₂ may be determined.

Now two different paths may be taken, denoted by conditional step 73 in FIG. 4, depending on the number of measurements N already performed. If aforementioned measurements in steps 63 and 69 were first measurements, i.e. N=0, the method proceeds to step 75. In step 75, a contrast value CV is determined by calculation using the formula:

$$CV = \frac{( {I}_{1} - {I}_{2} )}{( {I}_{1} + {I}_{2} )} \qquad ( 1 )$$

Subsequently, in step 77, the contrast value as determined is stored in memory 48 as a reference contrast value CV_{ref}. The polarization measurement assembly is now ready for monitoring. As the number of measurements now equals 1, N is raised by 1 in step 79.

Alternatively, if aforementioned measurements in steps 63 and 69 were not first measurements, i.e. N>0, the method proceeds to step 81. In this case, in step 81, again a contrast value is determined by calculation using the same formula as mentioned earlier, i.e. formula 1. Subsequently, however, in step 83, a polarization purity is established by comparing the CV as determined in step 81 with the reference CV_{ref} as stored in the memory in step 77. If further measurements are desired, steps 61 until 71 may again be performed. To keep track of the number of measurements, N may again be raised, in step 85, by 1.

The method as depicted in FIG. 4 can be performed sequentially for S-polarization and P-polarization. As a result, different reference contrast value CV_{ref} may be determined and stored, i.e. a contrast value for s-polarization, i.e. CVₛ, and a contrast value for P-polarization, i.e. CVₚ.

### EXAMPLE

Consider the following values for I_{1,s}, I_{2,s}, I_{1,p} and I_{2,p} measured at t=0 by using the method as described with reference to FIG. 4 (in arbitrary units):
I_{1,s}=76;
I_{2,s}=50;
I_{1,p}=62;
I_{2,p}=64;
Consequently,

$${CV}_{s} = \frac{( {I}_{1 , s} - {I}_{2 , s} )}{( {I}_{1 , s} + {I}_{2 , s} )} = \vert \frac{( 76 - 50 )}{( 76 + 50 )} \vert = 0.206$$

$${CV}_{p} = \frac{( {I}_{1 , p} - {I}_{2 , p} )}{( {I}_{1 , p} + {I}_{2 , p} )} = \vert \frac{( 62 - 64 )}{( 62 + 64 )} \vert = 0.016$$

Aforementioned values are stored in memory 48 as reference values. After some time, with the polarization measurement assembly of FIG. 3a, another measurement is performed for monitoring purposes, i.e. the method as explained with reference to FIG. 4 is used. After measurement of I₁ and I₂ for s-polarization, a CVS of 0.200 is determined. A comparison of this value with the reference value results in a polarization purity of (0.200/0.206)*100%=97%.

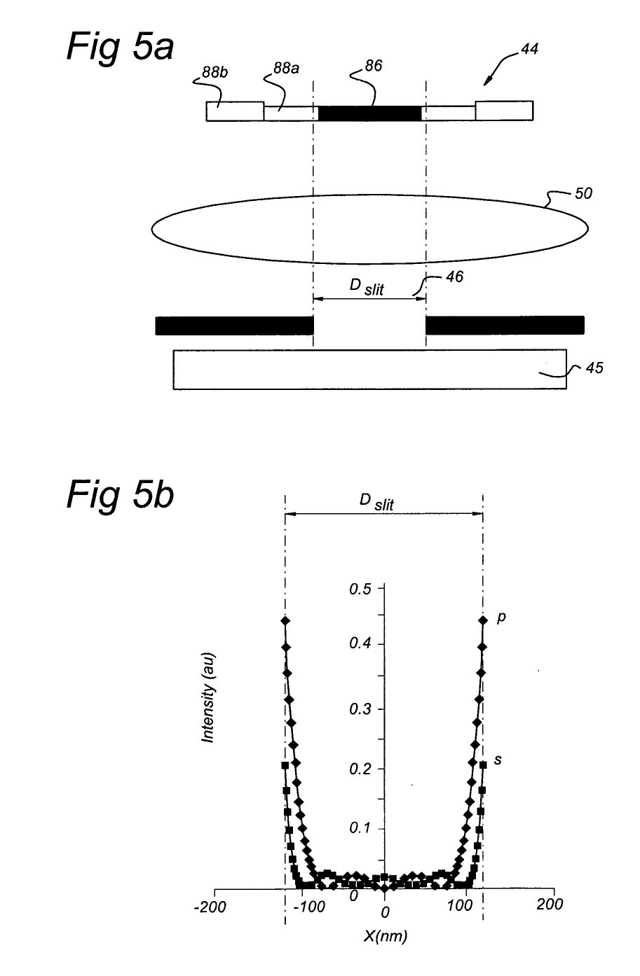

FIG. 5a schematically depicts a more detailed view of a second variant of a polarization measurement assembly as depicted in FIG. 2, according to another embodiment of the present invention. Instead of a pattern comprising lines and spaces, the polarization sensitive feature 44 of this embodiment comprises a blocking portion 86 alongside transparent portions with a different thickness, i.e. transparent portions 88a with a “normal” thickness and additional transparent portions with a different thickness 88b. The difference in thickness may be chosen in such a way that a 180 degree phase shift of the light between the transparent portions 88a and the additional transparent portions 88b. is established as is known from the field of phase shift mask technology. Again, light that passes the polarization sensitive feature 44, thus passes the blocking portion 86, is projected by a projection lens 50 on a slit 46 downstream of which an image sensor 45 is positioned. The image sensor 45 is arranged to take an intensity image of the light passing through the slit 46. Little light will reach the image sensor 45, as most of the radiation will be absorbed by the blocking portion 86 of the polarization sensitive feature 44. The part that passes and falls on the image sensor 45 is highly dependent on the polarization state of the light. This is due to polarization selective interference efficiency of the phase edges. In contrast to the first embodiment, the detector 43 does not need to move in the X-direction to obtain the desired polarization characteristics.

FIG. 5b depicts a graph showing a typical result of a polarization measurement with the polarization measurement assembly of FIG. 5a. Due to aforementioned alignment of the slit 46 and the blocking portion 86 of the polarization sensitive feature 44, image sensor 45 only detects substantial intensities at the edges of its measurement window. However, as the effect of the phase edges is different for s-polarization and p-polarization, and background intensities are blocked due to the blocking portion 80, this difference in integrated intensity may be used to characterize the polarization of the radiation that is employed, e.g. in a lithographic projection apparatus.

FIG. 6 depicts a flow chart of a method of monitoring integrated intensity of an image by using the polarization measurement assembly of FIG. 5a, according to an embodiment of the present invention. The operations in the flow chart may be part of a computer program product that may be executed by processor 47. Such a computer program may be stored on a data carrier (not shown).

First, in step 91, the detector 43 is positioned at a suitable position with respect to the polarization sensitive feature 44. After positioning of the detector 43, in step 93, an intensity of the image of the polarization sensitive feature 44 is measured with respect to S-polarized light. Based on this measurement, in step 95, an integrated intensity value S is determined. Subsequently, in step 97, an intensity of the image of the polarization sensitive feature 44 is measured. However, in this step the measurement is performed with respect to P-polarized light. Based on this measurement, in step 99, an integrated intensity value P is determined. Subsequently, in step 101, a difference D between S and P may be calculated. Finally, in step 103, the determined integrated intensity values S and P, and if calculated, difference D are stored in memory 48 as S_{ref}, P_{ref} and D_{ref} respectively.

Subsequently, at a moment somewhat later in time, in step 105, the intensity of the image of the polarization sensitive feature 44 is measured with respect to one of the types of radiation, e.g. S-polarized light. In this case, based on the measurement in step 105, in step 107, an integrated intensity value S₁ is determined. Subsequently, in step 109, a difference Dₛ is calculated between the integrated intensity value S₁, as determined in step 107, and the integrated intensity reference value S_{ref} as stored in the memory in step 103. Finally, in step 111, a polarization purity change is calculated by using Dₛ as calculated in step 109 and D_{ref} as stored in the memory in step 103. In order to keep track of developments, steps 105-111 can be repeated, as denoted by the dashed arrow in FIG. 6.

It will be understood that other measurement methods may be employed. For example, instead of measuring S-polarized light, P-polarized light may be measured in step 105. In that case, an integrated intensity value P₁ is determined in step 107. In yet another alternative, first the intensity of the image of polarization with respect to P-polarized light is measured and then the image of polarization with respect to S-polarized light, i.e. steps 93-95 and steps 97-99 are swapped.

### EXAMPLE

Consider the following values for S₁ and P₁, measured at t=0 by using the method as described with reference to FIG. 6:
S₁=1.00;
P₁=3.12;
Consequently, D_{ref}=3.12−1.00=2.12;
Now, at t=t₁, S₁ is measured to be 1.12. According to the method as described with reference to FIG. 6, the difference Dₛ now equals 1.12−1.00=0.12.
Thus a polarization purity decrease may be calculated by:
Dₛ/D_{ref}*100%=0.12/2.12*100%=5.7%.
   Both aforementioned embodiments of a method of monitoring an integrated intensity of an image by using a polarization measurement assembly, as described with reference to FIGS. 4 and 6, may be used to monitor polarization in a light projection apparatus, e.g. a lithographic projection apparatus. By using the polarization measurement assembly and an embodiment of aforementioned polarization measurement methods in combination with a processor and a memory, polarization irregularities may be readily detected.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A method of monitoring polarization performance of an optical system in a lithographic projection apparatus, said lithographic projection apparatus comprising an illumination system configured to condition a radiation beam and a support constructed to support a patterning device, the patterning device being capable of imparting the radiation beam with a pattern in its cross-section to form a patterned radiation beam; wherein the method comprises:
providing said patterning device, said patterning device having a polarization sensitive feature;
providing a detector configured to detect an image of said polarization sensitive feature;
providing a projection optical system configured to project, upon illumination of said polarization sensitive feature, said image on said detector;
measuring an image intensity of the image of said polarization sensitive feature as projected on said detector at a first moment in time;
determining a polarization-related parameter based on said image intensity as measured at said first moment in time.

2. The method according to claim 1, wherein said method further comprises:
measuring an image intensity of the image of said polarization sensitive feature as projected on said detector at a second moment in time;
determining said polarization-related parameter based on said image intensity as measured at said second moment in time;
comparing the polarization-related parameter as determined at said first moment in time and the polarization-related parameter as determined at said second moment in time.

3. The method according to claim 1, wherein said measuring an image intensity of an image of said polarization sensitive feature involves measurements at a first position and a second position of said detector.

4. The method according to claim 3, wherein said polarization-related parameter is a contrast value CV determined by the formula:
$$CV = \frac{( {I}_{1} - {I}_{2} )}{( {I}_{1} + {I}_{2} )}$$
wherein
I₁ is a spatially integrated image intensity as measured at said first position, and
I₂ is a spatially integrated image intensity as measured at said second position.

5. The method according to claim 4, further comprising:. measuring an image intensity of the image of said polarization sensitive feature as projected on said detector at a second moment in time;
determining said contrast value CV based on said image intensity as measured at said second moment in time;
establishing a polarization purity by comparing the contrast value CV as determined at said first moment in time and the contrast value CV as determined at said second moment in time.

6. The method according to claim 1, wherein said measuring an image intensity of an image of said polarization sensitive feature involves a first measurement of S-polarized light and a second measurement of P-polarized light.

7. The method according to claim 6, wherein said polarization-related parameter is a difference D_{ref} between a spatially integrated image intensity S_{ref} as measured in said first measurement of S-polarized light and a spatially integrated image intensity P_{ref} as measured in said second measurement of P-polarized light.

8. The method according to claim 7, further comprising:
measuring an image intensity of the image of said polarization sensitive feature as projected on said detector at a second moment in time of S-polarized light;
determining a spatially integrated image intensity S as measured in said measurement of S-polarized light at said second moment in time;
determining a difference Dₛ between the spatially integrated image intensity S_{ref} measured at said first moment in time and the spatially integrated image intensity S₁. measured at said second moment in time;
calculating a polarization purity change by comparing difference D_{ref} as determined at said first moment in time and difference Dₛ as determined at said second moment in time.

9. The method according to claim 7, wherein said method further comprises:
measuring an image intensity of the image of said polarization sensitive feature as projected on said detector at a second moment in time of P-polarized light;
determining a spatially integrated image intensity P₁ as measured in said measurement of P-polarized light at said second moment in time;
determining a difference Dₚ between the spatially integrated image intensity P_{ref} measured at said first moment in time and the spatially integrated image intensity P₁ measured at said second moment in time;
calculating a polarization purity change by comparing difference D_{ref} as determined at said first moment in time and difference Dₚ as determined at said second moment in time.

10. A polarization measurement assembly to measure polarization of a beam of radiation traversing through a projection optical system, said polarization measurement assembly comprising:
an optical element provided with a polarization sensitive feature;
a detector comprising a slit and an image sensor, said detector being arranged to receive an image of said polarization sensitive feature upon illumination of said optical element with said beam of radiation, said image being projected on said detector by means of said projection optical system.

11. The polarization measurement assembly according to claim 10, wherein the polarization sensitive feature comprises a pattern of lines and spaces with a pitch d, and said slit has a slit diameter of Dₛₗᵢₜ, said slit diameter being unequal to said pitch.

12. The polarization measurement assembly according to claim 11, wherein a relation between said slit diameter and said pitch is given by the relation
$${D}_{slit} = \frac{3}{2} d .$$

13. The polarization measurement assembly according to claim 11, wherein said detector is moveable in a direction substantially perpendicular to said pattern of lines and spaces.

14. The polarization measurement assembly according to claim 10, wherein said polarization sensitive feature comprises:
a blocking portion configured to block radiation;
a first transparent portion at a first side of said blocking portion and a second transparent portion at a second side of said blocking portion, said first side and second side being opposing sides; and
a first additional transparent portion alongside said first transparent portion, and a second additional transparent portion alongside said second transparent portion; wherein said first and second transparent portion have a different thickness than said first and second additional transparent portion.

15. The polarization measurement assembly according to claim 14, wherein said different thickness is chosen as to cause a 180 degree phase shift between the first transparent portion and the first additional transparent portion, and a 180 degree phase shift between the second transparent portion and the second additional transparent portion.

16. A lithographic apparatus comprising:
an illumination system configured to condition a radiation beam; a support constructed to support a patterning device, the patterning device being capable of imparting the radiation beam with a pattern in its cross-section to form a patterned radiation beam;
a substrate table constructed to hold a substrate; and
a projection system configured to project the patterned radiation beam onto a target portion of the substrate;
a polarization measurement assembly configured to measure polarization of a beam of radiation through the projection system, the polarization measurement system comprising:
an optical element provided with a polarization sensitive feature;
a detector comprising a slit and an image sensor, said detector being arranged to receive an image of said polarization sensitive feature upon illumination of said optical element with said beam of radiation, said image being projected on said detector by means of said projection optical system.

17. A device manufacturing method, comprising transferring a pattern from a patterning device onto a substrate using a lithographic apparatus, the lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate table constructed to hold a substrate; and
a projection system configured to project the patterned radiation beam onto a target portion of the substrate;
a polarization measurement assembly configured to measure polarization of a beam f radiation through the projection system, the polarization measurement system comprising:
an optical element provided with a polarization sensitive feature;
a detector comprising a slit and an image sensor, said detector being arranged to receive an image of said polarization sensitive feature upon illumination of said optical element with said beam of radiation, said image being projected on said detector by means of said projection optical system.

18. A computer program product for performing, when executed by a processor, a method of monitoring polarization performance of an optical system in a lithographic projection apparatus, said lithographic projection apparatus comprising an illumination system configured to condition a radiation beam and a support constructed to support a patterning device, the patterning device being capable of imparting the radiation beam with a pattern in its cross-section to form a patterned radiation beam, wherein the method comprises:
measuring an image intensity of an image of a polarization sensitive feature of said patterning device as projected on a detector configured to detect an image of said polarization sensitive feature, at a first moment in time;
determining a polarization-related parameter based on said image intensity as measured at said first moment in time.
